(19) United States
(12) Patent Application Publication
(10) Pub. No.: US 2013/0132600 A1
(43) Pub. Date: May 23, 2013

(54) APPARATUS AND METHOD OF A PORTABLE TERMINAL FOR PERFORMING COMMUNICATION WITH A DEVICE SUPPORTING MEDIA TRANSFER PROTOCOL

(71) Applicant: Samsung Electronics Co., Ltd, Gyeonggi-do (KR)

(72) Inventor: Dong-Gyu Park, Hwaseong-si (KR)

(73) Assignee: SAMSUNG ELECTRONICS CO., LTD, Gyeonggi-do (KR)

(21) Appl. No.: 13/679,723

(22) Filed: Nov. 16, 2012

(30) Foreign Application Priority Data
Nov. 22, 2011 (KR) 10-2011-0122192

(51) Int. Cl. H04L 29/06

(52) U.S. Cl. CPC H04L 65/60
USPC 709/230

(57) ABSTRACT

According to one embodiment, a method of operating a portable terminal includes, when a device is connected to the portable terminal, confirming that the connected device supports a first protocol, recognizing the device as a storage device, and communicating with the device recognized as the storage device.

### CROSS-REFERENCE TO RELATED APPLICATION(S) AND CLAIM OF PRIORITY

The present application is related to and claims the benefit under 35 U.S.C. §119(a) to a Korean Patent Application filed in the Korean Intellectual Property Office on Nov. 22, 2011 and assigned Serial No. 10-2011-0122192, the entire disclosure of which are hereby incorporated by reference.

### TECHNICAL FIELD OF THE INVENTION

The present invention relates to an apparatus and method of a portable terminal for performing communication with a device which supports a media transport protocol.

### BACKGROUND OF THE INVENTION

With the advancement of multimedia techniques, devices have been developed to be compatible with various other devices, thus providing sharing of data between devices. For example, a photo captured by a digital camera can be connected to a Portable Computer (PC) so that the photo stored in the digital camera can be stored into the PC or the photo stored in the digital camera can be displayed in the PC.

In addition, by connecting a portable terminal and a device, a large-sized file stored in the device can be transmitted to the portable terminal. For example, the portable terminal can perform communication with a device which supports a Media Transfer Protocol (MTP), and can transmit a file stored in the device to the portable terminal.

Although a portable terminal which uses a Windows™ Operating System (OS) and a device which supports the MTP may be compatible and thus can perform mutual communication, the mutual communication cannot be performed with a portable terminal which uses a Mac™ or Linux™ OS due to lack of compatibility. Therefore, an additional application needs to be provided when using the Mac™ or Linux™ OS since there is no way of transmitting a file to the device which supports the MTP, and even if the additional application is provided, there is a problem in that compatibility with other programs cannot be maintained.

### SUMMARY OF THE INVENTION

To address the above-discussed deficiencies of the prior art, it is a primary object to provide at least the advantages described below. Accordingly, an aspect of the present invention is to provide an apparatus and method configured to perform communication between a portable terminal and a device in such a manner that the portable terminal simulates the device as a portable disk when connecting the portable terminal which uses a Mac™ or Linux™ Operating System (OS) and the device which supports a Media Transfer Protocol (MTP).

Another aspect of the present invention is to provide an apparatus and method in which a portable disk can be directly connected in a Mac™ or Linux™ finder, and a user can copy, delete, and move a file stored in a device by using the finder.

Another aspect of the present invention is to provide an apparatus and method in which a terminal which supports an MTP is recognized as a portable disk in a portable terminal and thus all applications of the portable terminal are compatible when only the portable disk is connected.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example portable terminal and a device according to an exemplary embodiment of the present invention;

FIG. 2 illustrates an example process of recognizing a device in a portable terminal according to an embodiment of the present invention;

FIG. 3 illustrates an example process of calling a file stored in a device in a portable terminal according to an embodiment of the present invention;

FIG. 4 illustrates an example process of transmitting a file stored in a device to a portable terminal according to an embodiment of the present invention;

FIG. 5 illustrates an example structure of a portable terminal according to an embodiment of the present invention; and

FIG. 6 illustrates an example structure of a device according to an embodiment of the present invention.

### DETAILED DESCRIPTION OF THE INVENTION

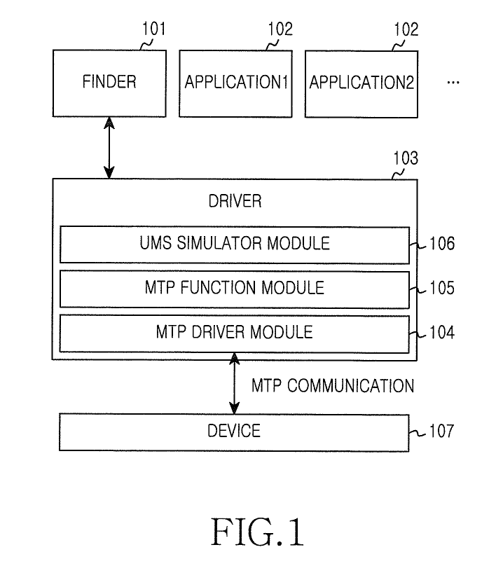

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged computing device. Example embodiments of the present invention will be described herein below with reference to the accompanying drawings. In the following description, well-known functions or constructions are not described in detail since they would obscure the invention in unnecessary detail. Also, the terms used herein are defined according to the functions of the present invention. Thus, the terms may vary depending on user's or operator's intension and usage. That is, the terms used herein must be understood based on the descriptions made herein. Further, like reference numerals denote parts performing similar functions and actions through the drawings.

FIG. 1 illustrates an example portable terminal and a device according to an embodiment of the present invention. Referring to FIG. 1, the portable terminal of the portable terminal includes a finder 101, at least one application 102, and a driver 103. A device 107 is one that supports a Media Transfer Protocol (MTP). The portable terminal of the present invention is a portable terminal which uses a Mac™ Operating System (OS) or a Linux™ OS. Further, the driver 103 of the portable terminal includes an MTP driver module 104, an MTP function module 105, and a Universal Mass Storage (UMS) simulator module 106.

First, in order to perform MTP communication between the portable terminal and the device 107, the device 107 is connected to the portable terminal. As described above, the device 107 connected to the portable terminal supports the MTP. Herein, the MTP refers to a Media Transfer Protocol, and is a standard protocol configured to transmit at least one file stored in the device to another device. More specifically, it is possible to transfer a specific file stored in one device to another device through software provided by a vender. The MTP has an advantage in that fast file transfer is possible from one device to another device, and also has an advantage when ordering a playlist. However, there is a disadvantage in that file transfer may not be supported in a portable disk mode.

As described above, the portable terminal of the present invention uses the MAC™ OS or the Linux™ OS. More specifically, among several OSs of the portable terminal, the MAC™ OS or the Linux™ OS cannot perform mutual communication with the device which supports the MTP. For example, although a portable terminal which uses a Windows™ OS and the device which supports the MTP are compatible and thus can perform communication, the portable terminal which uses the MAC™ OS or the Linux™ OS and the device which supports the MTP are generally not compatible and thus cannot perform communication. However, the portable terminal of the present invention provides mutual communication between the portable terminal which uses the MAC™ OS or the Linux™ OS and the device which supports the MTP. Hereinafter, a process of performing communication will be described in greater detail.

When the device 107 is connected to the driver 103 of the portable terminal, the MTP driver module 104 included in the driver 103 of the portable terminal loads the device 107 and confirms that the device 107 is a device which supports the MTP. More specifically, as described above, the portable terminal which uses the MAC™ OS or the Linux™ OS cannot load the device which supports the MTP. However, in the present invention, the MTP driver module 104 is included in the driver 103 of the portable terminal, and thus it can be confirmed that the device 107 connected to the portable terminal is the device which supports the MTP.

Thereafter, the MTP driver module 104 performs a handshaking process with the device 107 to recognize the MTP. Herein, the handshaking process refers to an operation of exchanging data. A normal handshaking process will be described herein below. A first step includes collecting a security function in which a message including a protocol version, a session IDentifier (ID), a password combination, a compression scheme, and an initial random number is exchanged between a client and a server. More specifically, the client first delivers a client_hello message to the server, and upon receiving this message, the server delivers a server_hello message to the client. A second step includes a server authentication and key exchange step in which a certificate, key exchange is sent to the client to request a certificate only when it is necessary in the server. Thereafter, the server reports to the client that the step of delivering the hello message ends. That is, the server sends a certificate, server_key_exchange, certificate_request, and finally sends a server_hello_done message. A third step includes a client authentication and key exchange step in which the client sends a certificate requested by the server, and sends a confirmation message for the key exchange and certificate to the server. A fourth step includes, when a handshake protocol ends, a password combination is exchanged. As described above, in the present disclosure, the handshaking process is performed for MTP recognition between the portable terminal and the device 107.

Upon confirming that the device 107 connected to the portable terminal supports the MTP, the MTP driver module 104 handshakes with the device 107 to recognize the MTP, and thereafter reports to the MTP function module 105 that the device 107 connected to the portable terminal supports the MTP. Upon receiving the report from the MTP driver module 104 that the device 107 connected to the portable terminal supports the MTP, the MTP function module 105 reports again to the UMS simulator module 106 that the device 107 connected to the portable terminal supports the MTP.

Thereafter, the UMS simulator module 106 simulates as if the device connected to the portable terminal is a portable disk, and reports the result to at least one allocation 102 stored in the portable terminal. More specifically, the UMS simulator module 106 simulates the device 107 which is connected to the portable terminal and which supports the MTP as a portable disk, and thus reports the result to the higher-level application 102 as if the device 107 connected to the portable terminal is the portable disk. Therefore, the device 107 which supports the MTP can also be connected to a portable terminal which uses the MAC™ OS or the Linux™ OS, so that mutual communication can be possible between the portable terminal and the device. That is, the at least one application 102 stored in the portable terminal is recognized as if the portable terminal is connected to the portable disk, and thus can transmit a file stored in the device 107 to the portable terminal. Upon completion of the aforementioned process, a recognition process ends in which the portable terminal and the device can perform mutual communication.

Upon completion of the mutual recognition process for performing MTP communication between the portable terminal and the device 107, a specific command of the application 102 stored in the portable terminal can be performed. Herein, the specific command may include at least one of a command for calling at least one file list stored in the device 107, a command for calling a file, a command for deleting the file, a command for modifying a file name, and a command for inputting specific data to the file. Hereinafter, a process of transmitting the file stored in the device 107 to the application 102 will be described in detail under the assumption that the aforementioned specific command is the command for calling the file stored in the device 107.

First, if a specific application calls a specific file stored in the device 107 among at least one application 102 stored in the portable terminal, the UMS simulator module 106 included in the driver 103 of the portable terminal receives a command for calling a specific file stored in the device 107 from the specific allocation. The command for calling the specific file can be configured with a specific function format. More specifically, the specific application 102 stored in the portable terminal recognizes the device 107 connected to the portable terminal as a portable disk, and transmits a command having a function format for calling a specific file stored in the portable disk to the UMS simulator module 106.

The UMS simulator module 106 receives a command having a function format for calling a specific file stored in the device 107 from the specific application 102, and converts it into an MTP function format. More specifically, as described above, the device connected to the portable terminal is a device which supports the MTP but the portable terminal recognizes it as a portable disk. In order for the portable terminal to perform communication with the device, the command having the function format for calling the specific file needs to be converted again into the MTP function format. That is, the UMS simulator module 106 converts the command having the function format for calling the specific file stored in the device 107 into the MTP function format, and transmits it to the MTP function module 105.

The MTP function module 105 receives the command having the MTP function format from the UMS simulator module 106, and generates data suitable for transmitting the received command to the device 107. More specifically, the MTP function module 105 confirms the command received in the MTP function format from the UMS simulator module 106, and generates suitable data so that the command is recognized by the device 107 connected to the portable terminal. That is, the aforementioned data is data which is used to allow the device 107 to recognize the command for calling a specific file stored in the device 107.

When the MTP function module 105 generates data for calling a specific file to be delivered to the device, the generated data is transmitted to the MTP driver module 104. The MTP driver module 104 receives the aforementioned data from the MTP function module 105, and performs communication with the device 107 connected to the portable terminal. Thereafter, upon receiving data regarding the aforementioned response result from the device 107, the MTP driver module 104 transmits data received from the MTP function module 105.

The MTP function module 105 receives data from the MTP driver module 104, parses the received data, and transmits the parsing result to the UMS simulator module 106. Herein, parsing generally refers to interpreting a source (e.g., a program language, etc.) according to a defined grammar. That is, the MTP function module 105 interprets data received from the MTP driver module 104, and transmits the interpretation result to the UMS simulator module 106.

The UMS simulator module 106 converts a first specific file into a function format, and transmits the result to the specific application 102 which calls the specific file. This is because the specific application 102 recognizes the device 107 connected to the portable terminal as a portable disk, and thus in order for the application 102 to recognize the result, the result needs to be transmitted again in a function format for calling the file.

When the application 102 which delivers a first file call command receives the result from the UMS simulator module 106, a file call process completely ends. Although a process of calling a specific file stored in the device 107 has been described in the aforementioned example, it is also possible to use a command for calling a file list stored in the device, a command for deleting a file, a command for modifying a file name, and a command for inputting specific data to the file.

Hereinafter, an operation of a device which communicates with a portable terminal will be described in detail. The device 107 which is connected to the portable terminal and which communicates with the portable terminal is a device which supports the MTP, and can transmit at least one file stored in the device 107 to the portable terminal. First, specific data is received from the MTP driver module 104 included in the driver 103 of the portable terminal. Herein, the specific data may include at least one of data for calling at least one file list stored in the device 107, data for calling a file, data for deleting the file, data for modifying a file name, and/or data for inputting specific data to the file.

In the following descriptions, the specific data is assumed to include data for calling at least one file. The device 107 receives data for calling, a specific file stored in the device 107 from the MTP driver module 104 of the portable terminal. Upon receiving the data for calling the specific data, the device 107 selects the data, and transmits the data again to the MTP driver module 104 of the portable terminal. Then, this process is complete. Although calling of the specific file stored in the device 107 has been described in the aforementioned example, it is also possible to use a command for calling a file list stored in the device, a command for deleting a file, a command for modifying a file name, and a command for inputting specific data to the file.

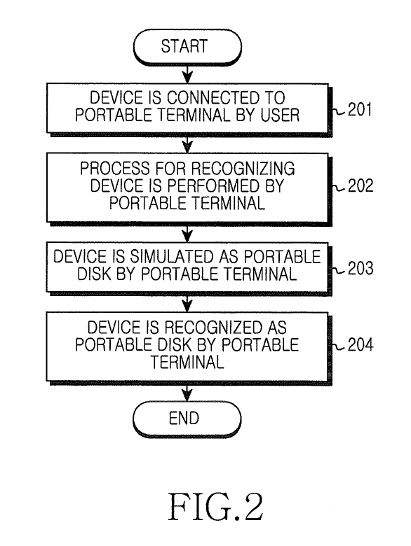

FIG. 2 illustrates an example process of recognizing a device in a portable terminal according to an embodiment of the present invention. Referring to FIG. 2, the device is connected to the portable terminal (step 201). Herein, the portable terminal refers to a portable terminal which uses a MAC™ OS or a Linux™ OS among several OSs. In addition, the device supports an MTP. More specifically, the portable terminal which uses the Mac™ OS or the Linux™ OS cannot perform mutual communication with the device which supports the MTP. This is because the portable terminal is not mutually compatible with the device which supports the MTP as in a portable terminal which uses a window OS, and thus communication cannot be performed.

When the device is connected to the portable terminal, the portable terminal performs a process of recognizing the device (step 202). More specifically, an MTP driver module included in a driver of the portable terminal confirms that the device connected to the portable terminal is the device which supports the MTP. Thereafter, the MTP driver module handshakes with the device to recognize the MTP. After the portable terminal confirms that the device connected to the portable terminal is the device which supports the MTP, upon completion of the handshaking with the device to recognize the MTP, the process of first recognizing the device by the portable terminal ends.

After performing the process of recognizing the device by the portable terminal, the portable terminal simulates the device as a portable disk (step 203). More specifically, the MTP driver module of the portable terminal reports to the MTP function module that the device connected to the portable terminal is the device which supports the MTP. Thereafter, the MTP function module reports again to the UMS simulator module that the device connected to the portable terminal supports the MTP. Upon receiving the report indicating, that the device connected to the portable terminal supports the MTP from the MTP function module, the UMS simulator module simulates the device as a portable disk. That is, the device connected to the portable terminal is simulated as if it is the portable disk other than the device which supports the MTP.

After the portable terminal simulates the device as the portable disk, the portable terminal recognizes the device as if it is the portable disk (step 204). More specifically, at least one application stored in the portable terminal recognizes the device connected to the portable terminal as if it is the portable disk, rather than the device which supports the MTP. That is, as described above, the UMS simulator module of the portable terminal simulates the device connected to the portable terminal as the portable disk and transmits the simulation result to a higher-level application stored in the portable terminal. Therefore, according to the present invention, the portable terminal which uses the Mac™ OS or the Linux™ OS can perform mutual communication with the device which supports the MTP.

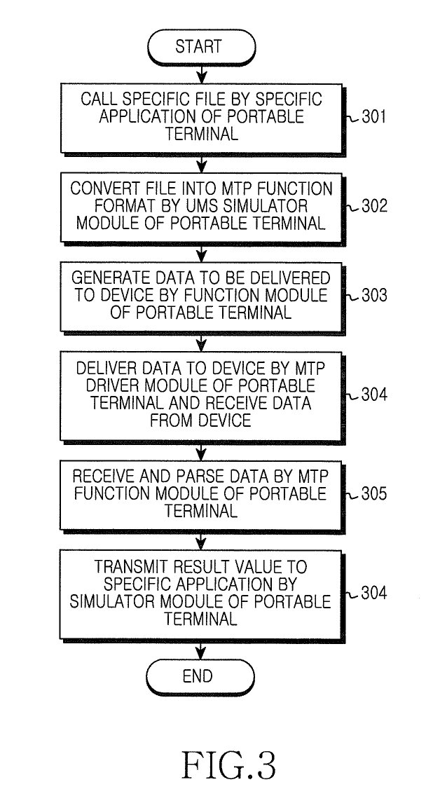

FIG. 3 illustrates an example process of calling a file stored in a device in a portable terminal according to an embodiment of the present invention. Referring to FIG. 3, a specific application of the portable terminal calls a specific file (step 301). More specifically, among at least one application stored in the portable terminal, when the specific application calls a specific file stored in the device, a UMS simulator module included in a driver of the portable terminal receives a command for calling the specific file stored in the device from the specific application. The command for calling the specific file can be configured with a specific function format. That is, the specific application stored in the portable terminal recognizes the device connected to the portable terminal as a portable disk, and transmits a command having a function format for calling a specific file stored in the portable disk to the UMS simulator module.

After receiving the call of the specific file from the specific application of the portable terminal, the UMS simulator module of the portable terminal converts the file into an MTP function format. More specifically, the UMS simulator module receives a command having a function format for calling a specific file stored in the device from the specific application, and converts the command into an MTP function format. As described above, the device connected to the portable terminal is a device which supports the MTP but the portable terminal recognizes it as a portable disk. In order for the portable terminal to perform communication with the device, the command having the function format for calling the specific file needs to be converted again into the MTP function format. That is, the UMS simulator module converts the command having the function format for calling the specific file stored in the device into the MTP function format, and transmits it to the MTP function module.

Thereafter, the function module of the portable terminal generates data to be delivered to the device (step 303). More specifically, the MTP function module receives the command having the MTP function format from the UMS simulator module, and generates data suitable for transmitting the received command to the device. More specifically, the MTP function module confirms the command received in the MTP function format from the UMS simulator module, and generates suitable data so that the command is recognized by the device connected to the portable terminal. That is, the aforementioned data is data which is used to allow the device to recognize the command for calling a specific file stored in the device.

Upon generation of data to be delivered to the device, the MTP driver module of the portable terminal delivers the data to the device, and receives data from the device (step 304). More specifically, when the MTP function module generates data for calling a specific file to be delivered to the device, the generated data is transmitted to the MTP driver module. The MTP driver module receives the aforementioned data from the MTP function module, and performs communication with the device connected to the portable terminal. Thereafter, upon receiving data regarding the aforementioned response result from the device, the MTP driver module transmits data received from the MTP function module.

Upon receiving data from the device, the MTP function module of the portable terminal receives the data and parses the data (step 305). More specifically, the MTP function module receives data from the MTP driver module, parses the received data, and transmits the parsing result to the UMS simulator module. That is, the MTP function module interprets data received from the MTP driver module, and transmits the interpretation result to the UMS simulator module.

Next, the simulator module of the portable terminal transmits the result value to the specific application (step 306). More specifically, the UMS simulator module converts a first specific file into a function format, and transmits the result to the specific application which calls the specific file. This is because the specific application recognizes the device connected to the portable terminal as a portable disk, and thus in order for the application to recognize the result, the result needs to be transmitted again in a function format for calling the file. Although a process of calling a specific file stored in the device has been described in the aforementioned example, it is also possible to use a command for calling a file list stored in the device, a command for deleting a file, a command for modifying a file name, and a command for inputting specific data to the file.

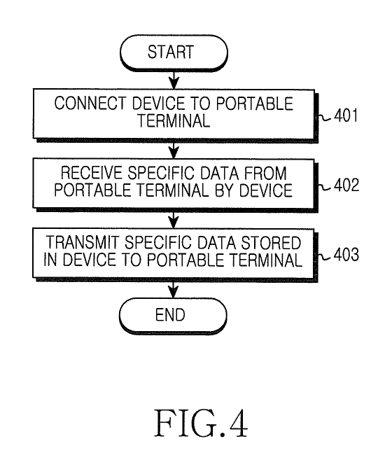

FIG. 4 illustrates an example process of transmitting a file stored in a device to a portable terminal according to an embodiment of the present invention. Referring to FIG. 4, the device is connected to the portable terminal (step 401). More specifically, the portable terminal communicates with the device by using a MAC™ OS or a Linux™ OS, and the device supports an MTP. That is, although the portable terminal which uses the Mac™ OS or the Linux™ OS is not mutually compatible with the device which supports the MTP and thus cannot communicate with the device, the present disclosure provides a first operation for performing mutual communication by simulating the device as if it is a portable disk.

When the device is connected to the portable terminal, the device receives specific data from the portable terminal (step 402). More specifically, the specific data is received from the MTP driver module located in the driver of the portable terminal. Herein, the specific data may include at least one of data for transmitting at least one file list stored in the device, data for transmitting a file, data for deleting the file, data for modifying a file name, and data for inputting specific data to the file. As described above, in the present embodiment, data stored in the portable terminal is transmitted to the portable terminal, and specific data is data for transmitting at least one file stored in the device to the portable terminal.

Upon receiving specific data from the portable terminal, the device transmits the specific data stored in the device to the portable terminal (step 403). More specifically, upon receiving the specific data from the portable terminal, the device transmits a corresponding file, that is, response data for the request, to the portable terminal. Upon completion of transmission of the specific data stored in the device to the portable terminal, the process of transmitting the file stored in the device to the portable terminal completely ends.

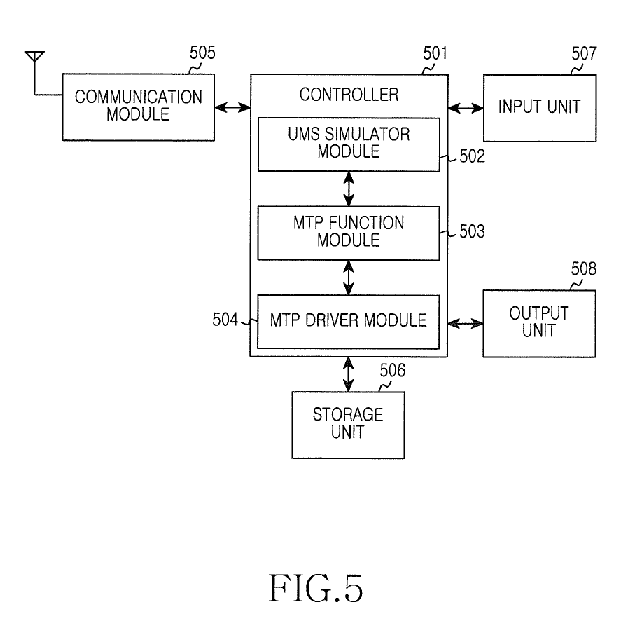

FIG. 5 illustrates an example structure of a portable terminal according to an embodiment of the present invention. Referring to FIG. 5, the portable terminal of the present invention includes a controller 501, a communication module 505, a storage unit 506, an input unit 507, and an output unit 508.

The controller 501 provides overall control to the portable terminal. In the present invention, the controller 501 may include a UMS simulator module 502, an MTP function module 503, and an MTP driver module 504.

The UMS simulator module 502 simulates a device as another device, and receives a request for a specific command from at least one application.

The MTP function module 503 communicates with the device, converts the specific command into at least one piece of data so as to be transmitted to the device, converts the data into a specific command so as to be able to confirm the data, and parses the data received from the device. In addition, the MTP function module 503 converts the command into an MTP function which matches to the command, confirms the MTP function, and generates at least one piece of data to be transmitted to the device.

The MTP driver module 504 is connected to the device, and confirms that the device is a device which supports an MTP, and handshakes with the device to recognize the MTP. In addition, the MTP driver module 504 transmits data to the device, and receives at least one piece of data from the device.

The communication module 505 processes a signal which is transmitted and received through an antenna for voice and data communication.

The storage unit 506 may include a program storage unit for storing a program for controlling an operation of the portable terminal and a data storage unit for storing data generated while the program is executed.

The input unit 507 provides the controller 501 with input data generated by a user's selection.

The output unit 508 displays state information, a menu screen, and story information of the portable terminal under the control of the controller 501. For example, the output unit 508 consists of a touch screen.

In the aforementioned structure, the controller 501 can perform overall functions of the terminal. However, these functions are separately configured and illustrated in the present invention to describe the respective functions separately. Therefore, when the product is implemented in practice, all functions of the portable terminal may be processed by the controller 501 or only some of the functions of the portable terminals may be processed by the controller 501.

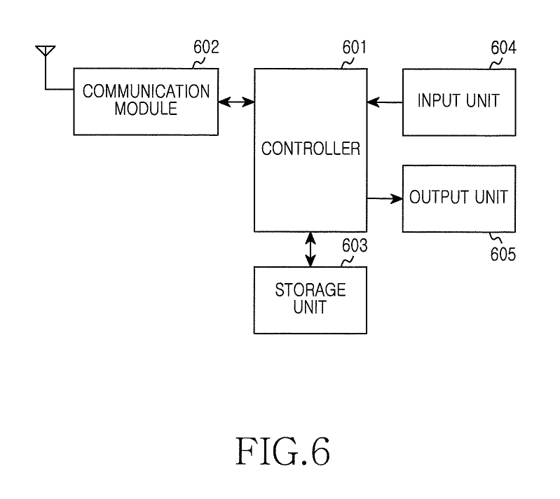

FIG. 6 illustrates an example structure of a device according to an embodiment of the present invention. Referring to FIG. 6, the device of the present invention includes a controller 601, a communication module 602, a storage unit 603, an input unit 604, and an output unit 605.

The controller 601 provides overall control to the device. For example, the controller 601 handshakes with the portable terminal to recognize an MTP.

The communication module 602 processes a signal which is transmitted and received through an antenna for voice and data communication. For example, the communication module 602 is connected to a portable terminal which uses a Mac™ OS or a Linux™ OS to communicate with the portable terminal, receives at least one piece of data from the portable terminal, receives a result of performing a process which matches to the data from the controller 601, and transmits the result to the portable terminal.

The storage unit 603 may include a program storage unit for storing a program for controlling an operation of the device and a data storage unit for storing data generated while the program is executed.

The input unit 604 provides the controller 601 with input data generated by a user's selection.

The output unit 605 displays state information, a menu screen, and story information of the portable terminal under the control of the controller 601. For example, the output unit 605 consists of a touch screen.

In the aforementioned structure, the controller 601 can perform overall functions of the terminal. However, these functions are separately configured and illustrated in the present invention to describe the respective functions separately. Therefore, when the product is implemented in practice, all functions of the portable terminal may be processed by the controller 601 or only some of the functions of the portable terminals may be processed by the controller 601.

It will be appreciated that embodiments of the present invention according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the present invention has been particularly shown and described with reference to various embodiments thereof, it will be understood by those skilled in the art that various changes in form and details may be made therein without departing from the spirit and scope of the present invention as defined by the appended claims.

What is claimed is:

1. A method of operating a portable terminal, the method comprising:
when a device is connected to the portable terminal, confirming that the connected device supports a first protocol;
recognizing the device as a storage device; and
communicating with the device recognized as the storage device.

2. The method of claim 1, wherein an Operating System (OS) of the portable terminal includes at least one of a Mac™ OS and a Linux™ OS.

3. The method of claim 1, further comprising handshaking with the device to recognize the first protocol.

4. The method of claim 1, wherein the storage device includes a Universal Mass Storage (UMS).

5. The method of claim 1, wherein the communicating with the simulated device comprises:
confirming a determined command by receiving the command from a user;
converting the command into at least one piece of data; and
transmitting the data to the device.

6. The method of claim 5, wherein the converting of the command into the at least one piece of data comprises:
converting the command into a first protocol function which matches the command; and
generating at least one piece of data to be transmitted to the device by confirming the first protocol function.

7. The method of claim 5, further comprising:
receiving at least one piece of data from the device;
converting the data into the command to confirm the data; and
confirming the command.

8. The method of claim 7, wherein the command includes at least one of a command for calling at least one file list stored in the device, a command for calling a file, a command for deleting the file, a command for modifying a file name, and a command for inputting specific data to the file.

9. The method of claim 7, further comprising parsing data received from the device.

10. The method of claim 1, wherein the first protocol includes a Media Transfer Protocol (MTP).

11. A portable terminal apparatus comprising:
a controller configured to confirm that, when a device is connected to the portable terminal, the connected device supports a first protocol, recognize the device as a storage device, and to communicate with the device recognized as the storage device; and
a storage device, connected to the controller, configured to store generated data.

12. The apparatus of claim 11, wherein an Operating System (OS) of the portable terminal includes at least one of a Mac™ OS and a Linux™ OS.

13. The apparatus of claim 11, wherein the controller includes a Media Transfer Protocol (MTP) driver module configured to handshake with the device to recognize the first protocol.

14. The apparatus of claim 11, wherein the storage device includes a Universal Mass Storage (UMS).

15. The apparatus of claim 11, wherein the controller comprises:
a UMS simulator module configured to confirm a determined command by receiving the command from a user;
an MTP function module configured to convert the command into at least one piece of data; and
an MTP driver module configured to transmit the data to the device.

16. The apparatus of claim 15, wherein the controller is configured to convert the command into a first protocol function which matches the command, and generate at least one piece of data to be transmitted to the device by confirming the first protocol function.

17. The apparatus of claim 15, wherein the controller comprises:
an MTP driver module configured to receive at least one piece of data from the device;
an MTP function module configured to convert the data into the command so as to confirm data; and
at least one application configured to confirm the command.

18. The apparatus of claim 17, wherein the command includes at least one of a command for calling, at least one file list stored in the device, a command for calling a file, a command for deleting the file, a command for modifying a file name, and a command for inputting specific data to the file.

19. The apparatus of claim 17, wherein the MTP function module parses data received from the device.

20. The apparatus of claim 11, wherein the first protocol includes an MTP function.
